(19) United States
(12) Patent Application Publication
(10) Pub. No.: US 2015/0171534 A1
(43) Pub. Date: Jun. 18, 2015

(54) CARD CONNECTOR AND ELECTRONIC APPARATUS

(71) Applicant: Kabushiki Kaisha Toshiba, Tokyo (JP)

(72) Inventors: Satoru Yasui, Kokubunji-shi (JP); Takahiro Sakaguchi, Ome-shi (JP); Kei Akiyama, Tachikawa-shi (JP)

(21) Appl. No.: 14/459,082

(22) Filed: Aug. 13, 2014

Related U.S. Application Data
(60) Provisional application No. 61/917,159, filed on Dec. 17, 2013.

(51) Int. Cl. H01R 12/72; H01R 13/633

(52) U.S. Cl. CPC H01R 12/721; H01R 13/633

(57) ABSTRACT

According to one embodiment, a card connector in which a card-shaped storage medium having card terminals is inserted so as to be extracted includes connector terminals configured to contact the card terminals and a terminal protecting member. The terminal protecting member includes a coated portion configured to maintain the connector terminals in a state of being in no contact with the card-shaped storage medium while the card-shaped storage medium is inserted in the card housing module up to contact positions where the card terminals contact the connector terminals.

### CROSS-REFERENCE TO RELATED APPLICATIONS

This application claims the benefit of U.S. Provisional Application No. 61/917,159, filed Dec. 17, 2013, the entire contents of which are incorporated herein by reference.

### FIELD

Embodiments described herein relate generally to a card connector and electronic apparatus.

### BACKGROUND

In electronic apparatuses such as digital cameras, smartphones and cellphones, for example, card-shaped storage media such as SD cards are used as data storage media. The card-shaped storage media are configured to be inserted into or extracted from card connectors provided at the electronic apparatuses.

When a card-shaped storage medium is inserted into a card connector, a plurality of card terminals provided on the card-shaped storage medium are brought into contact with a plurality of connector terminals provided at the card connector.

Incidentally, according to the card-shaped storage medium, each card terminal is provided in a position recessed from a surface of the card-shaped storage medium. In other words, a stepped wall is formed at a boundary portion between each card terminal and the surface of the card type storage medium.

For this reason, when the card-shaped storage medium is inserted in or extracted from the card connector, each connector terminal often abuts on or engages with the stepped wall. As a result, each connector terminal may be bent or buckled.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1A is an exemplary front view showing a camera of an embodiment seen from a photographing lens;

FIG. 1B is an exemplary plan view showing a structure of a card-shaped storage medium applied to the embodiment;

FIG. 1C is an exemplary plan view showing a structure of another card-shaped storage medium applied to the embodiment;

FIG. 2 is an exemplary perspective view showing an appearance of a card connector of the embodiment;

FIG. 3A is an exemplary perspective view showing an inner structure of the card connector of the embodiment in which an eject lever is moved up to a card insertion position;

FIG. 3B is an exemplary perspective view showing the inner structure of the card connector of the embodiment in which the eject lever is moved up to a card extraction position;

FIG. 4A is an exemplary perspective view showing a structure of a terminal protecting member of the card connector of the embodiment in which the terminal protecting member is moved up to the card insertion position;

FIG. 4B is an exemplary perspective view showing the structure of the terminal protecting member of the card connector of the embodiment in which the terminal protecting member is moved up to the card extraction position;

FIG. 5A is an exemplary cross-sectional view schematically showing a state in which a connector terminal is brought into contact with a card terminal through a through hole of the terminal protecting member;

FIG. 5B is an exemplary cross-sectional view schematically showing a state in which the terminal protecting member is moved in accordance with a card inserting or extracting operation; and

FIG. 5C is an exemplary cross-sectional view schematically showing a state in which the terminal protecting member is located in a card insertion or extraction position.

### DETAILED DESCRIPTION

Various embodiments will be described hereinafter with reference to the accompanying drawings. In general, according to one embodiment, a card connector in which a card-shaped storage medium having card terminals arranged in positions recessed from a surface is inserted so as to be extracted, includes connector terminals provided in a card housing module and configured to contact the card terminals of the card-shaped storage medium and a terminal protecting member configured to move between the card-shaped storage medium and the connector terminals in accordance with operations of inserting and extracting the card-shaped storage medium. The terminal protecting member includes a coated portion configured to maintain the connector terminals in a state of being in no contact with the card-shaped storage medium while the card-shaped storage medium is inserted in the card housing module up to contact positions where the card terminals contact the connector terminals. The coated portion includes through holes which intervene between the connector terminals and the card terminals and urge the connector terminals to contact the card terminals when the card-shaped storage medium is inserted in the contact positions of the card housing module.

The embodiment will be described hereinafter with reference to the accompanying drawings.

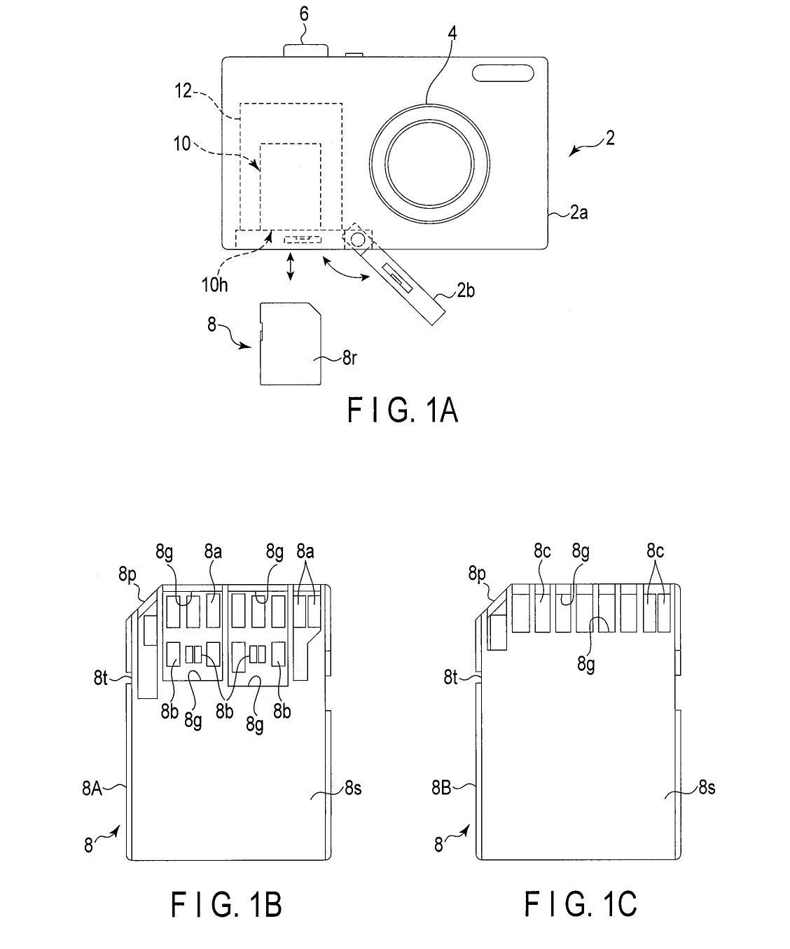

FIG. 1A shows a camera 2 as an example of an electronic apparatus. In a housing 2a (hereinafter called a camera body) of the camera 2, for example, a photographing lens 4 and a shutter button 6 are provided besides a shutter, an image pickup element, an optical finder, etc. (not shown).

When the shutter button 6 is fully pressed, the shutter is opened. At this time, light passing through the photographing lens 4 strikes the image pickup element and a subject image is captured through an optical finder.

A card connector 10 which allows a card-shaped storage medium 8 such as an SD card to be inserted therein or extracted therefrom as a data storage medium is built in the camera body 2a.

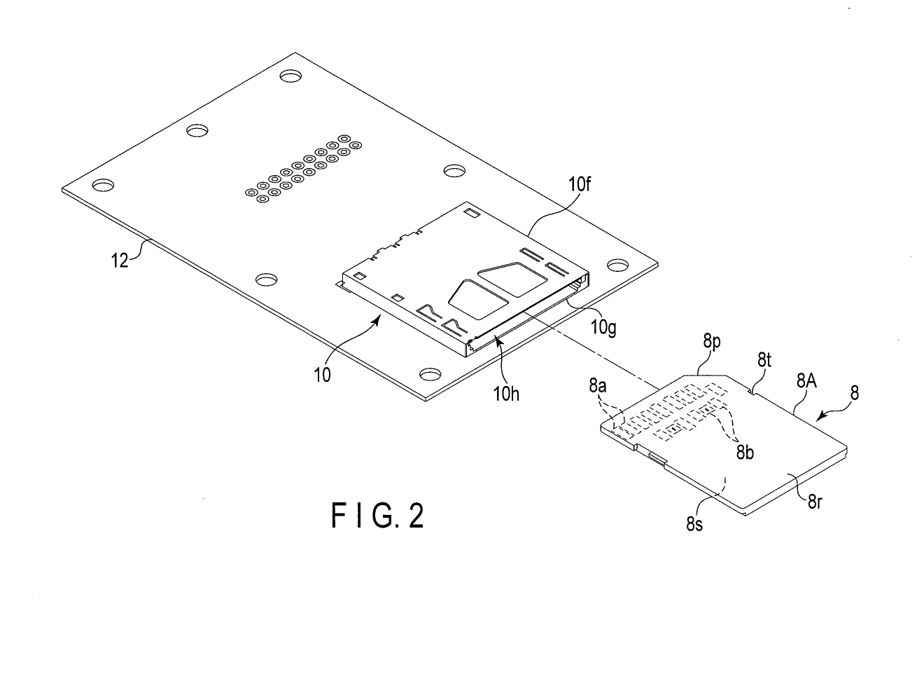

The card connector 10 is mounted on a board 12 formed of an insulator on which a wiring pattern (not shown) is printed, and comprises a base 10g fixed on the board 12 and a cover 10f attached to cover the base 10g, as shown in FIG. 2.

A card insertion/extraction opening 10h surrounded by the base 10g and the cover 10f is constituted at one of edge sides of the card connector 10. An opening/closing door 2b (see FIG. 1A) is provided on the camera body 2a, opposite to the card insertion/extraction opening 10h, so as to open and close. The card-shaped storage medium 8 can be inserted in the card connector 10 through the card insertion/extraction opening 10h so as to be extracted therefrom, by opening the opening/closing door 2b.

A plural-row-terminal type card-shaped storage medium 8A (see FIG. 1B) having a plurality of card terminals 8a and 8b aligned in two rows along the inserting/extracting direction or a single-row-terminal type card-shaped storage medium 8B (see FIG. 10) having a plurality of card terminals 8c aligned in a single row can be used as the card-shaped storage medium 8.

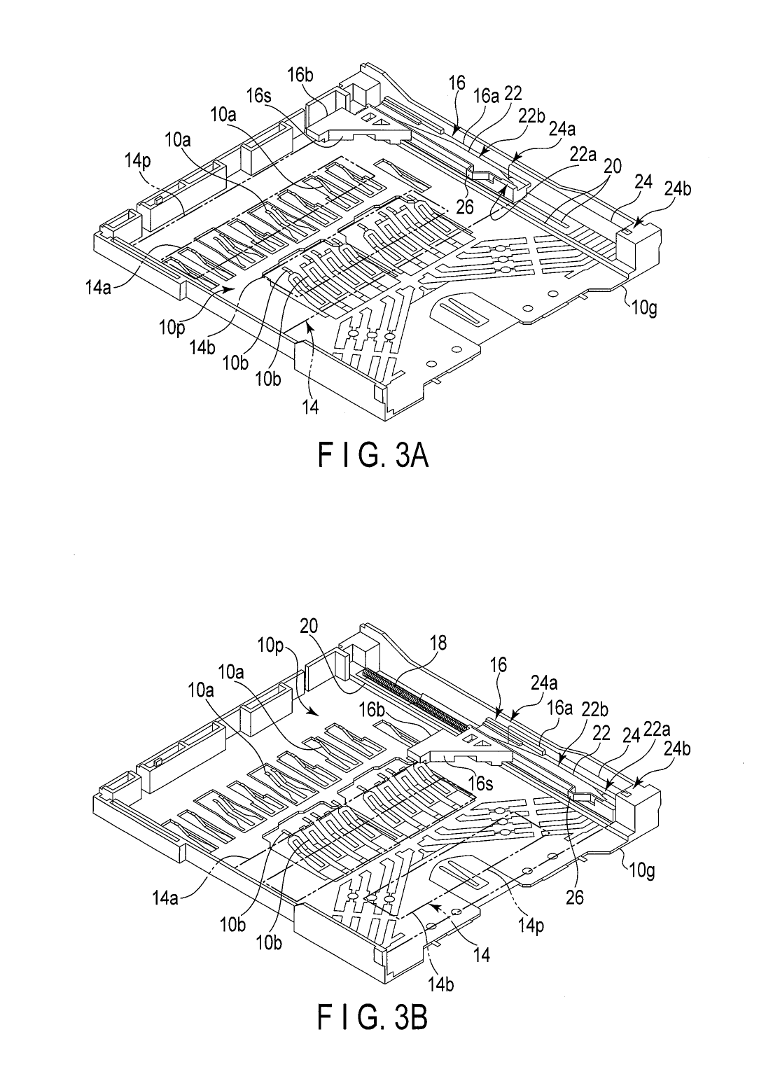

When the plural-row-terminal type card-shaped storage medium 8A is inserted in the card connector 10, the plurality of card terminals 8a and 8b (see FIG. 1B) provided on the card-shaped storage medium 8A are brought into contact with a plurality of connector terminals 10a and 10b (see FIG. 3A and FIG. 3B) provided on the card connector 10, respectively. At this time, the captured subject image data is stored in the card-shaped storage medium 8A by executing data communication between the connector terminals 10a and 10b and the card terminals 8a and 8b.

When the single-row-terminal type card-shaped storage medium 8B is inserted in the card connector 10, the plurality of card terminals 8c (see FIG. 10) provided on the card-shaped storage medium 8B are brought into contact with the plurality of connector terminals 10a (see FIG. 3A and FIG. 3B) provided on the card connector 10. At this time, the captured subject image data is stored in the card-shaped storage medium 8B by executing data communication between the connector terminals 10a and the card terminals 8c.

Each of the card-shaped storage media 8A and 8B has a surface 8s and a back surface 8r opposite to the surface 8s. Each of the card terminals 8a and 8b is provided in a position recessed from the surface 8s of each of the card-shaped storage media 8A and 8B. An amount of recess (i.e., depth of recess) of the card terminals 8a and 8b from the surface 8s of the card-shaped storage media 8A and 8B is defined to be within a certain range in the technical field of the card-shaped storage media 8A and 8B.

The plural-row-terminal type card-shaped storage medium 8A (see FIG. 1B) will be explained as an example in the following descriptions.

FIG. 3A and FIG. 3B show an inner structure of the card connector 10 in a state in which the cover 10f is detached from the base 10g. The card connector 10 comprises a card housing portion 10p in which the card-shaped storage medium 8A (hereinafter called plural-row-terminal card) inserted through the card insertion/extraction opening 10h is housed.

The plurality of connector terminals 10a and 10b which are brought into contact with the card terminals 8a and 8b, respectively, are provided in positions corresponding to the respective card terminals 8a and 8b of the plural-row-terminal card 8A, in the card housing portion 10p.

In other words, nine first card terminals 8a are provided at a downstream side of the card inserting direction, on the plural-row-terminal card 8A. The first card terminals 8a are aligned across the card inserting direction (see FIG. 1B).

Furthermore, eight second card terminals 8b are provided at a more upstream side of the card inserting direction than the first card terminals 8a, on the plural-row-terminal card 8A. The second card terminals 8b are aligned across the card inserting direction (see FIG. 1B).

On the other hand, nine first connector terminals 10a are provided at the card housing portion 10p so as to contact nine first card terminals 8a, respectively, in a state in which the plural-row-terminal card 8A is housed in the card housing portion 10p. The first connector terminals 10a are constituted to be in an attitude raised from the base 10g of the card connector 10, and elastically contact the first card terminals 8a, respectively.

Moreover, eight second connector terminals 10b are provided at the card housing portion 10p so as to contact eight second card terminals 8b, respectively, in a state in which the plural-row-terminal card 8A is housed in the card housing portion 10p. The second connector terminals 10b are constituted to be in an attitude raised from the base 10g of the card connector 10, and elastically contact the second card terminals 8b, respectively.

Moreover, in the card housing portion 10p, a terminal protecting member 14 configured to move between the plural-row-terminal card 8A and each of the connector terminals 10a and 10b, in accordance with the operation of inserting or extracting the plural-row-terminal card 8A, and a guide mechanism configured to guide the terminal protecting member 14 along the direction of inserting or extracting the plural-row-terminal card 8A, are provided.

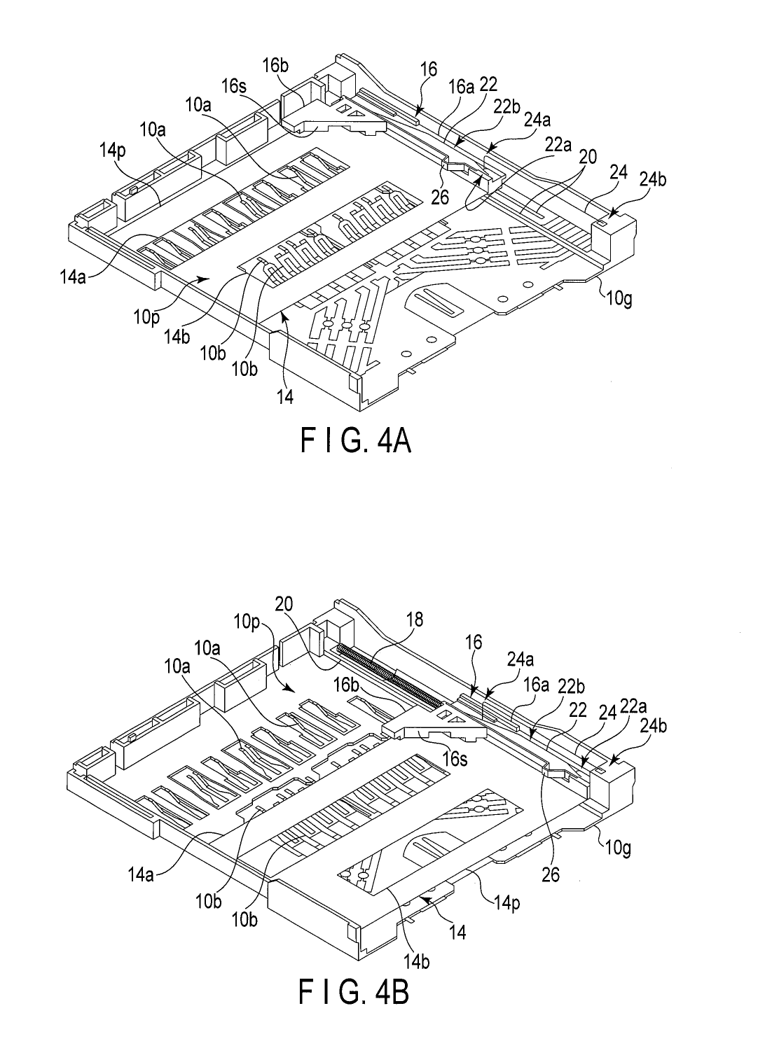

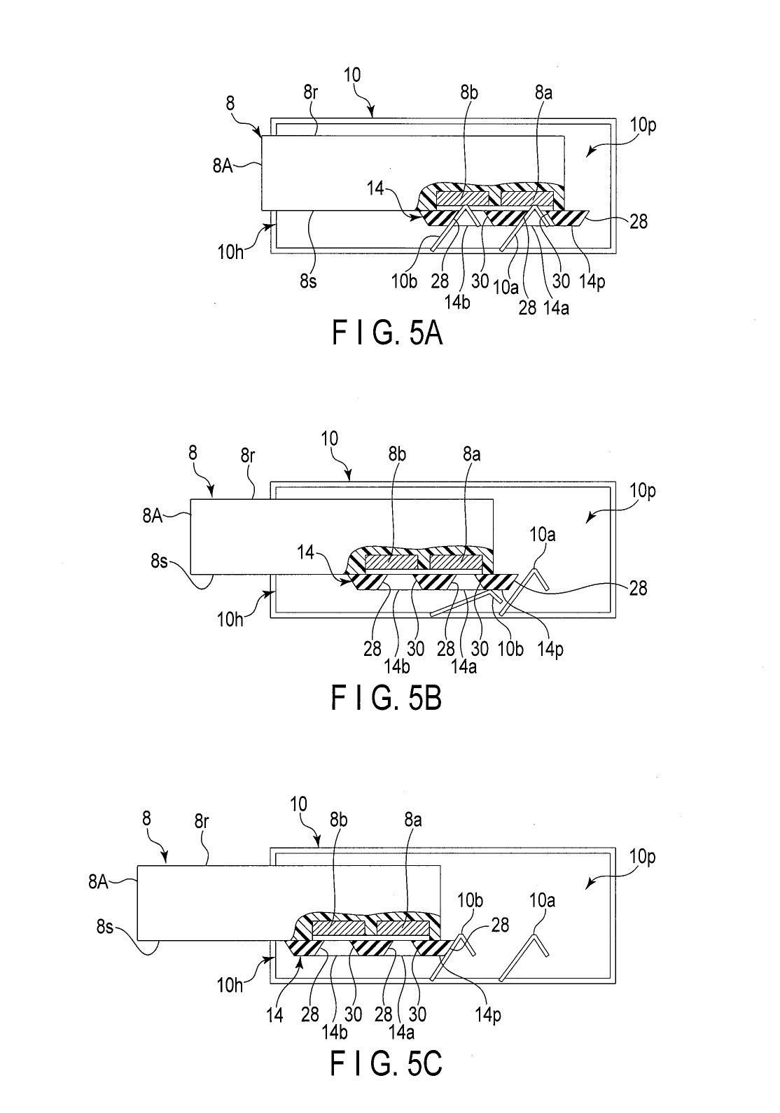

The terminal protecting member 14 is constituted such that the first card terminals 8a and the second card terminals 8b contact the first connector terminals 10a and the second connector terminals 10b only when the plural-row-terminal card 8A is housed in the card housing portion 10p, as shown in FIG. 4A, FIG. 4B and FIG. 5A.

In other words, the terminal protecting member 14 comprises a coated portion 14p constituted to hold the connector terminals 10a and 10b to be in no contact with the plural-row-terminal card 8A while the plural-row-terminal card 8A is inserted in the card housing portion 10p up to the contact position where the card terminals 8a and 8b contact the connector terminals 10a and 10b, respectively.

The coated portion 14p comprises two through holes 14a and 14b which intervene between the connector terminals 10a and 10b and the card terminals 8a and 8b, respectively, and urge the connector terminals 10a and 10b to contact the card terminals 8a and 8b when the plural-row-terminal card 8A is inserted up to the contact position in the card housing portion 10p.

In this case, the size and shape of the coated portion 14p of the terminal protecting member 14 are not particularly limited here since they are set in accordance with the size and shape of the card housing portion 10p. The size and shape of each of the through holes 14a and 14b formed on the coated portion 14p are not particularly limited here since they are set in accordance with the number, size and shape of each of the connector terminals 10a and 10b and each of the card terminals 8a and 8b.

In the present embodiment, the size and shape of the through hole 14a are set by considering the arrangement of each first card terminal 8a and each first connector terminal 10a in the contact position, and the size and shape of the through hole 14b are set by considering the arrangement of each second card terminal 8b and each second connector terminal 10b in the contact position.

The figures show the terminal protecting member 14 comprising the rectangular coated portion 14p, and the rectangular through holes 14a and 14b aligned in two rows along the inserting and extracting direction, as an example. The connector terminals 10a and 10b thereby become able to contact the card terminals 8a and 8b through the through holes 14a and 14b, respectively, only when the plural-row-terminal card 8A is inserted up to the contact position in the card housing portion 10p.

In the present embodiment, the guide mechanism is configured by employing a push/push-type ejection mechanism provided at the card connector 10 as it is. In other words, the guide mechanism comprises an eject lever 16 which is movable along the inserting and extracting direction of the plural-row-terminal card 8A and an urging member 18 (for example, compression coil spring) configured to urge the eject lever 16 in the extracting direction at any time.

The eject lever 16 comprises a slider portion 16a extending along the inserting and extracting direction of the plural-row-terminal card 8A and an eject portion 16b provided at a tip side of the slider portion 16a.

The slider portion 16a is configured to be movable along paired guide rails 20 provided in positions avoiding the card housing portion 10p. The paired guide rails 20 extend parallel to each other along the inserting and extracting direction of the plural-row-terminal card 8A.

The eject portion 16b is shaped to project from the slider portion 16a toward the card housing portion 10p, and comprises an abutting plane 16s which abuts on a cutaway portion 8p (see FIG. 1B and FIG. 2) at an insertion tip side of the plural-row-terminal card 8A.

The urging member 18 (compression coil spring) is inserted between the tip of the slider portion 16a and the base 10g so as to be compressible and deformable, and applies the urging force (pressurizing force) to the slider portion 16a at any time.

In this case, the eject portion 16b abuts on the cutaway portion 8p of the plural-row-terminal card 8A at any time during the insertion of the plural-row-terminal card 8A in the card housing portion 10p and the extraction of the plural-row-terminal card 8A from the card housing portion 10p. The operations of inserting and extracting the plural-row-terminal card 8A are thereby transmitted to the slider portion 16a via the eject portion 16b and urge the slider portion 16a to move along the paired guide rails 20. As a result, the eject lever 16 becomes movable in accordance with the operations of inserting the plural-row-terminal card 8A in the card housing portion 10p and extracting the plural-row-terminal card 8A from the card housing portion 10p.

A heart-cam mechanism is provided at the slider portion 16a. The heart-cam mechanism comprises a heart-cam groove 22 formed on a surface of the slider portion 16a and a pin member 24 guided along the heart-cam groove 22.

The heart-cam groove 22 comprises a cam groove portion 22a bent in a heart shape and a long groove portion 22b formed to unify from both sides of the cam groove portion 22a toward a tip side of the slider portion 16a. The pin member 24 has a free end 24a engaged with the heart-cam groove 22 and has a fixed end 24b supported on the base 10g to be freely rotatable.

If the plural-row-terminal card 8A is pushed from the card insertion/extraction opening 10h into the card housing portion 10p, the eject lever 16 moves against the urging force of the urging member 18 in accordance with the operation of pushing the plural-row-terminal card 8A. When the free end 24a of the pin member 24 is guided from the long groove portion 22b to the cam groove portion 22a and engages with the cam groove portion 22a, the urging force of the urging member 18 is supported by the pin member 24. The plural-row-terminal card 8A can be thereby housed in the card housing portion 10p. At this time, an engagement element 26 provided on the slider portion 16a engages with a recess portion 8t (see FIG. 1B and FIG. 2) of the plural-row-terminal card 8A. As a result, the plural-row-terminal card 8A cannot be extracted from the card housing portion 10p.

In this state, if the plural-row-terminal card 8A is pushed into the card housing portion 10p again, the engagement of the engagement element 26 with the recess portion 8t of the plural-row-terminal card 8A is canceled and the engagement of the free end 24a of the pin member 24 with the cam groove portion 22a is canceled. At this time, the eject lever 16 is pushed back by the urging force of the urging member 18. The plural-row-terminal card 8A can be thereby ejected from the card housing portion 10p.

In the present embodiment, the terminal protecting member 14 is integrated with the eject lever 16. As the integrating method, a method of retrofitting the terminal protecting member 14 to the eject lever 16 by, for example, bonding, screwing, etc., a method of integrating the terminal protecting member 14 with the eject lever 16, etc. can be applied.

In the integration, when the plural-row-terminal card 8A is housed in the card housing portion 10p (see FIG. 5A), the terminal protecting member 14 is positioned in view of the eject lever 16 such that the card terminals 8a and 8b are in contact with the connector terminals 10a and 10b through the through holes 14a and 14b of the coated portion 14p, respectively.

A first inclined plane 28 is formed at the tip side of the terminal protecting member 14 in the inserting direction as shown in FIGS. 5A to 5C. A first inclined plane 28 and a second inclined plane 30 are formed to be opposite to each other, in each of the through holes 14a and 14b of the terminal protecting member 14. The first inclined plane 28 is positioned at a more upstream side in the inserting direction than the second inclined plane 30, in each of the through holes 14a and 14b.

When the plural-row-terminal card 8A is inserted, the first inclined planes 28 guide the connector terminals 10a and 10b in a direction of moving away from the plural-row-terminal card 8A and urge the connector terminals 10a and 10b to retreat to the coated portion 14p. At the insertion of the plural-row-terminal card 8A, the second inclined planes 30 guide the connector terminals 10a and 10b urged to retreat to the coated portion 14p, toward the plural-row-terminal card 8A. Furthermore, when the plural-row-terminal card 8A is extracted, the second inclined planes 30 guide the connector terminals 10a and 10b in the direction of moving away from the plural-row-terminal card 8A and urge the connector terminals 10a and 10b to retreat to the coated portion 14p.

An angle of inclination of the first inclined planes 28 and the second inclined planes 30 can be set, based on the arrangement of the connector terminals 10a and 10b. In the present embodiment, since the connector terminals 10a and 10b are constituted to be in an attitude raised from the base 10g of the card connector 10, the angle of inclination can be set, based on, for example, outlines, gradients, etc. of the connector terminals. In this case, the angle of inclination of the first inclined planes 28 and the second inclined planes 30 may be set at an angle corresponding to the outlines of the connector terminals 10a and 10b. Alternatively, the angle of inclination of the first inclined planes 28 and the second inclined planes 30 may be set at an angle corresponding to the gradients of the connector terminals 10a and 10b.

In this structure, at the insertion of the card, the terminal protecting member 14 is moved in accordance with the operation of inserting the plural-row-terminal card 8A (see FIG. 5C), each second connector terminal 10b is guided in the direction of moving away from the plural-row-terminal card 8A to retreat to the coated portion 14p by the first inclined plane 28 (see FIG. 5B) and, subsequently, each first connector terminal 10a is guided in the direction of moving away from the plural-row-terminal card 8A to retreat to the coated portion 14p by the first inclined plane 28. At this time, each second connector terminal 10b is moved from the second inclined plane 30 to the first inclined plane 28, in the through hole 14a, and is positioned on the coated portion 14p again.

When the plural-row-terminal card 8A is housed in the card housing portion 10p, the second connector terminals 10b elastically contact the second card terminals 8b, respectively, through the through hole 14b, and the first connector terminals 10a elastically contact the first card terminals 8a, respectively, through the through hole 14a (see FIG. 5A).

At the extraction of the card, the terminal protecting member 14 is moved in accordance with the operation of extracting the plural-row-terminal card 8A (see FIG. 5A), each first connector terminal 10a is guided in the direction of moving away from the plural-row-terminal card 8A by the second inclined plane 30 and is urged to retreat from the through hole 14a to the coated portion 14p (see FIG. 5B) and, subsequently, each second connector terminal 10b is guided in the direction of moving away from the plural-row-terminal card 8A by the second inclined plane 30 and is urged to retreat from the through hole 14b to the coated portion 14p.

When the plural-row-terminal card 8A is extracted from the card housing portion 10p, the connector terminals 10a and 10b are released from the terminal protecting member 14 and thereby return to the initial state by their own elastic force.

According to the present embodiment, as described above, the connector terminals 10a and 10b can be maintained in the state of being in no contact with the plural-row-terminal card 8A except the card terminals 8a and 8b, by providing the terminal protecting member 14 configured to move in accordance with the operations of inserting and extracting the plural-row-terminal card 8A, between the plural-row-terminal card 8A and the connector terminals 10a and 10b. Each of the connector terminals 10a and 10b can be thereby prevented from abutting or hitching on a stepped wall 8g (see FIG. 1B) at a boundary between the card terminals 8a and 8b and the surface 8s of the plural-row-terminal card 8A, when the card is inserted and extracted. Therefore, each of the connector terminals 10a and 10b can be prevented from being bent or buckled. As a result, use of the card connector 10 can be continued for a long time.

Furthermore, according to the present embodiment, since a mechanism to move the terminal protecting member 14 does not need to be additionally provided by integrating the terminal protecting member 14 with the eject lever 16, reduction of the number of components can be attempted accordingly. As a result, rise in the manufacturing costs of the card connector 10 can be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A card connector in which a card-shaped storage medium having a surface and a plurality of card terminals arranged in positions recessed from the surface is inserted so as to be extracted, the card connector comprising:
a card housing module in which the card-shaped storage medium is inserted;
a plurality of connector terminals provided in the card housing module and configured to contact the plurality of card terminals of the card-shaped storage medium; and
a terminal protecting member provided in the card housing module and configured to move between the card-shaped storage medium and the plurality of connector terminals in accordance with operations of inserting and extracting the card-shaped storage medium,
wherein
the terminal protecting member comprises a coated portion configured to maintain the plurality of connector terminals in a state of being in no contact with the card-shaped storage medium while the card-shaped storage medium is inserted in the card housing module up to contact positions where the plurality of card terminals contact the plurality of connector terminals, and
the coated portion comprises through holes which intervene between the plurality of connector terminals and the plurality of card terminals and urge the plurality of connector terminals to contact the plurality of card terminals when the card-shaped storage medium is inserted in the contact positions of the card housing module.

2. The card connector of claim 1, further comprising a guide mechanism configured to guide the terminal protecting member along directions of inserting and extracting the card-shaped storage medium.

3. The card connector of claim 2, wherein
the guide mechanism comprises an eject lever configured to move along the directions of inserting and extracting the card-shaped storage medium, and to urge the card-shaped storage medium to be ejected at the extraction, and
the terminal protecting member is integrated with the eject lever.

4. The card connector of claim 1, wherein
the terminal protecting member comprises:
a first inclined plane which guides the plurality of connector terminals in a direction of moving away from the card-shaped storage medium and urges the plurality of connector terminals to retreat to the coated portion when the card-shaped storage medium is inserted; and
a second inclined plane which guides each of the plurality of connector terminals urged to retreat to the coated portion, toward the card-shaped storage medium, when the card-shaped storage medium is inserted, and
the second inclined plane guides the plurality of connector terminals in the direction of moving away from the card-shaped storage medium and urges the plurality of connector terminals to retreat to the coated portion when the card-shaped storage medium is extracted.

5. The card connector of claim 4, wherein
the first inclined plane is provided at a tip side of the terminal protecting member in the inserting direction, and
the first inclined plane and the second inclined plane are provided to be opposite to each other, at the through hole of the terminal protecting member.

6. The card connector of claim 5, wherein
the first inclined plane is positioned at a more upstream side in the inserting direction than the second inclined plane, at the through hole of the terminal protecting member.

7. An electronic apparatus comprising:
a housing; and
a card connector which is provided inside the housing and in which a card-shaped storage medium having a surface and a plurality of card terminals arranged in positions recessed from the surface is inserted so as to be extracted,
wherein
the card connector comprises:
a card housing module in which the card-shaped storage medium is inserted;
a plurality of connector terminals provided in the card housing module and configured to contact the plurality of card terminals of the card-shaped storage medium; and
a terminal protecting member provided in the card housing module and configured to move between the card-shaped storage medium and the plurality of connector terminals in accordance with operations of inserting and extracting the card-shaped storage medium,
the terminal protecting member comprises a coated portion configured to maintain the plurality of connector terminals in a state of being in no contact with the card-shaped storage medium while the card-shaped storage medium is inserted in the card housing module up to contact positions where the plurality of card terminals contact the plurality of connector terminals, and
the coated portion comprises through holes which intervene between the plurality of connector terminals and the plurality of card terminals and urge the plurality of connector terminals to contact the plurality of card terminals when the card-shaped storage medium is inserted in the contact positions of the card housing module.

8. The apparatus of claim 7, further comprising a guide mechanism configured to guide the terminal protecting member along directions of inserting and extracting the card-shaped storage medium.

9. The apparatus of claim 8, wherein
the guide mechanism comprises an eject lever configured to move along the directions of inserting and extracting the card-shaped storage medium, and to urge the card-shaped storage medium to be ejected at the extraction, and
the terminal protecting member is integrated with the eject lever.

10. The apparatus of claim 7, wherein
the terminal protecting member comprises:
a first inclined plane which guides the plurality of connector terminals in a direction of moving away from the card-shaped storage medium and urges the plurality of connector terminals to retreat to the coated portion when the card-shaped storage medium is inserted; and
a second inclined plane which guides each of the plurality of connector terminals urged to retreat to the coated portion, toward the card-shaped storage medium, when the card-shaped storage medium is inserted, and
the second inclined plane guides the plurality of connector terminals in the direction of moving away from the card-shaped storage medium and urges the plurality of connector terminals to retreat to the coated portion when the card-shaped storage medium is extracted.

11. The apparatus of claim 10, wherein
the first inclined plane is provided at a tip side of the terminal protecting member, in the inserting direction, and
the first inclined plane and the second inclined plane are provided to be opposite to each other, at the through hole of the terminal protecting member.

12. The apparatus of claim 11, wherein
the first inclined plane is positioned at a more upstream side in the inserting direction than the second inclined plane, at the through hole of the terminal protecting member.
